(19) United States
(12) Patent Application Publication
(10) Pub. No.: US 2026/0094192 A1
(43) Pub. Date: Apr. 2, 2026

(54) SYSTEMS AND METHODS FOR MULTI-VARIANT ITEM SEARCH RESULT DISPLAY OPTIMIZATION

(71) Applicant: rewardStyle, Inc., Dallas, TX (US)

(72) Inventor: Alok GOYAL, Seattle, WA (US)

(21) Appl. No.: 19/346,670

(22) Filed: Oct. 1, 2025

Related U.S. Application Data
(60) Provisional application No. 63/702,395, filed on Oct. 2, 2024.

(51) Int. Cl. G06Q 30/0601; G06F 16/28

(52) U.S. Cl. CPC G06Q 30/0627; G06F 16/285; G06Q 30/0641

(57) ABSTRACT

An item search query may be received. A plurality of items responsive to the query and a plurality of similarity scores corresponding to the items may be determined. The items may include two or more item variants of a multi-variant item. A plurality of clusters, each including a subset of the items, may be generated, where at least two of the item variants are included in a same cluster. Within each cluster, a corresponding subset of the similarity scores may be associated with and used to order the subset of items within the cluster. A cluster iteration sequence may be set based on a comparison of a highest similarity score from each cluster, and a display sequence may be generated for presenting the items within an optimized user interface based on the cluster iteration sequence to reduce a display redundancy of the at least two item variants.

### CROSS-REFERENCE TO RELATED APPLICATIONS

This application claims the benefit of priority from U.S. Provisional Application No. 63/702,395, filed on October 02, 2024, which is incorporated by reference herein in its entirety.

### TECHNICAL FIELD

The present disclosure relates generally to systems and methods for search result display optimization, and more specifically systems and methods for reducing display redundancy of item variants of a multi-variant item presented in an optimized search result user interface.

### BACKGROUND

Item search platforms often leverage queryable data stores to facilitate execution of item searches. An example data store may store information associated with a large number of items. The items may include products or merchandise, each having a plurality of attributes (e.g., brand, collection, size, color, retailer, etc.). A subset of the items stored may be multi-variant items. A multi-variant item is an item having two or more item variants (e.g., item versions) that represent a same underlying item but have one or more differing attributes. Using a shoe as an example multi-variant item, the example data store may store two or more shoes of a same brand and collection, but having differing sizes, colors, styles, and/or retailers providing the shoes for purchase.

Using conventional search result display techniques, when an underlying item of a multi-variant item is responsive to a search query submitted to the data store, multiple item variants of the multi-variant item returned as search results may be displayed in a redundant manner within a search result user interface. For example, the search result user interface may display each of the multiple item variants immediately next to one another within the results. Resultantly, other unique items responsive to the search query and of similar relevance to the multiple item variants may be disadvantageously positioned within the user interface.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

The techniques of this disclosure improve the state of search result display by providing a technical solution to the technology-created problem of redundant item variant display within search result user interfaces.

The techniques described herein relate to methods, systems, and/or non-transitory computer readable mediums for search result display optimization. For example, a query for an item search initiated via a user computing device may be received. A plurality of items responsive to the query and a plurality of similarity scores corresponding to the plurality of items may be determined, where the plurality of items include two or more item variants of a multi-variant item. A plurality of clusters may be generated, where each of the plurality of clusters includes a subset of the plurality of items, and at least two of the two or more item variants are included in a same cluster of the plurality of clusters. Within each of the plurality of clusters, a corresponding subset of the plurality of similarity scores may be associated with the subset of the plurality of items included in the respective cluster, and the subset of the plurality of items may be ordered within the respective cluster based on the corresponding subset of the plurality of similarity scores. A cluster iteration sequence for item selection may be set based on a comparison of a highest similarity score from each of the plurality of clusters, and a display sequence for presenting the plurality of items may be generated based on the cluster iteration sequence. The user computing device may then be caused to construct and display an optimized user interface that presents at least a portion of the plurality of items according to the display sequence, where the display sequence reduces a display redundancy of the at least two of the two or more item variants in the optimized user interface.

### BRIEF DESCRIPTION OF THE DRAWINGS

The accompanying drawings, which are incorporated in and constitute a part of this specification, illustrate various example embodiments and together with the description, serve to explain the principles of the disclosed embodiments.

FIG. 1 is a diagram showing an example of a search environment, according to some embodiments of the disclosure.

FIG. 2 is a flow chart showing an example process for search result display optimization, according to some embodiments of the disclosure.

FIG. 3 is a system flow diagram conceptually showing the example process described in FIG. 2, according to some embodiments of the disclosure.

FIG. 4 is a conceptual diagram illustrating an example enhanced sorting process performed as part of the example process described in FIG. 2, according to some embodiments of the disclosure;

FIG. 5A is an example user interface displaying search results when the enhanced sorting process is disabled, according to some embodiments of the disclosure.

FIG. 5B is another example user interface displaying search results when the enhanced sorting process is enabled, according to some embodiments of the disclosure.

FIG. 6 shows an implementation of a computer system that executes techniques presented herein, according to some embodiments of the disclosure.

### DETAILED DESCRIPTION

As briefly mentioned above, application of conventional search result display techniques creates or causes item variant display redundancy. For example, based on conventional models, algorithms, and/or processes used to sort, rank, or otherwise arrange search results for display, multiple item variants of a multi-variant item returned as part of the search results may be displayed in a redundant manner within a search result user interface. For example, the search result user interface may display each of the multiple item variants immediately next to one another within the results. Resultantly, other unique items of similar search relevance to the multiple item variants may be disadvantageously positioned within the search result user interface. For example, multiple item variants of a highest-relevance multi-variant item may take up multiple positions next to one another at a top of the search result user interface, while other unique items of similarly high relevance may be pushed to lower positions on the search result user interface. Additionally, a lesser number of unique items overall may generally be displayed per page of results within the user interface.

The present disclosure solves these problems and/or other problems described above or elsewhere in the present disclosure, namely by implementing enhanced sorting processes to reduce item variant display redundancy within an optimized search result user interface. Specifically, in response to receiving a query for a search item, items corresponding to the search query and associated similarity scores may be determined. Clusters, each including different subsets of the items, may be generated using hash-based and/or embedding-based clustering, and the similarity scores may be associated with and used to order the subsets of the items within the clusters. Based on item-related information that is input to a hash-based clustering algorithm and/or item-related information represented in embeddings that are used to generate the clusters (e.g., via an embedding-based clustering), two or more item variants of any multi-variant item included in the items corresponding to the search query may often be grouped within the same cluster. Particularly, embedding-based clustering performed in addition to hash-based clustering may further increase a likelihood (e.g., may help to ensure) that the item variants are grouped within a same cluster. Such grouping within the same cluster is what causes the item variant display redundancy when applying conventional search result display techniques.

Therefore, to account for this problem and reduce the item variant display redundancy, an enhanced sorting process is implemented that includes setting a cluster iteration sequence for item selection, and generating a display sequence for presenting the items based on the cluster iteration sequence. For example, to generate the display sequence, an item from the subset of the items having a highest remaining similarity score is iteratively selected from each of the clusters according to an order of the clusters defined by the cluster iteration sequence. The order of the clusters from an initial cluster to a final cluster in the cluster iteration sequence may be based on a highest similarity score among each of the clusters. The cluster iteration sequence prevents two items from being selected from a same cluster sequentially, and thus two items from a same cluster being positioned immediately next to one another in the display sequence (at least initially until items available for selection have been depleted in all but one cluster). Therefore, given that item variants are often grouped within the same cluster, and the cluster iteration sequence at least initially prevents two items from being selected from a same cluster sequentially, the cluster iteration sequence prevents or at least reduces a likelihood of two or more item variants being sequentially selected and positioned immediately next to one another in the display sequence, and particularly within higher positions in the display sequence.

Computer-executable instructions configured to cause the user computing device to construct and display an optimized user interface that presents the items according to the display sequence may then be generated for execution by the user computing device. Based on the use of the display sequence to construct the optimized user interface, item variant display redundancy is reduced in the optimized user interface. For example, the optimized user interface may present unique items of highest relevance to the search query without any detracting item variants being positioned immediately next to one another (at least within a top portion of the user interface corresponding to the higher positions in the display sequence). Resultantly, a greater diversity of items of relevance may be presented at higher positions within the optimized user interface, and overall per page, while still enabling item variants to be presented for viewing and/or selection at lower positions within the optimized user interface. In this manner, the embodiments disclosed herein offer an improved technique for organizing and presenting information in a graphical user interface, resulting in a more effective and efficient navigation of the presented information. For example, the optimized user interface reduces the steps and time required for users to view a wider range of relevant items by generating and utilizing a unique display sequence. This sequence positions a greater diversity of relevant items more prominently within the interface, allowing users to quickly identify and complete tasks associated with those items in a more efficient manner.

Additionally, in some examples, a number of the items responsive to the query may be exorbitantly large. Having to cluster and sort such a large number of items using the processes described above may be computing resource intensive. Therefore, to help conserve computing resources, the items may be divided into portions, and only one portion of the items may be clustered and sorted at a time for presentation via an optimized user interface (e.g., on a page-by-page basis), as described in detail below. Additionally, by portioning the items for processing, a latency from a time of query submission to a time of result presentation via the optimized user interface may decrease.

While specific examples included throughout the present disclosure involve item search performed in a content creation platform context, it should be understood that techniques according to this disclosure may be adapted to any item search performed via a standalone search engine/platform or as part of a larger electronic commerce (e-commerce) platform. It should also be understood that the examples above are illustrative only. The techniques and technologies of this disclosure may be adapted to any suitable activity.

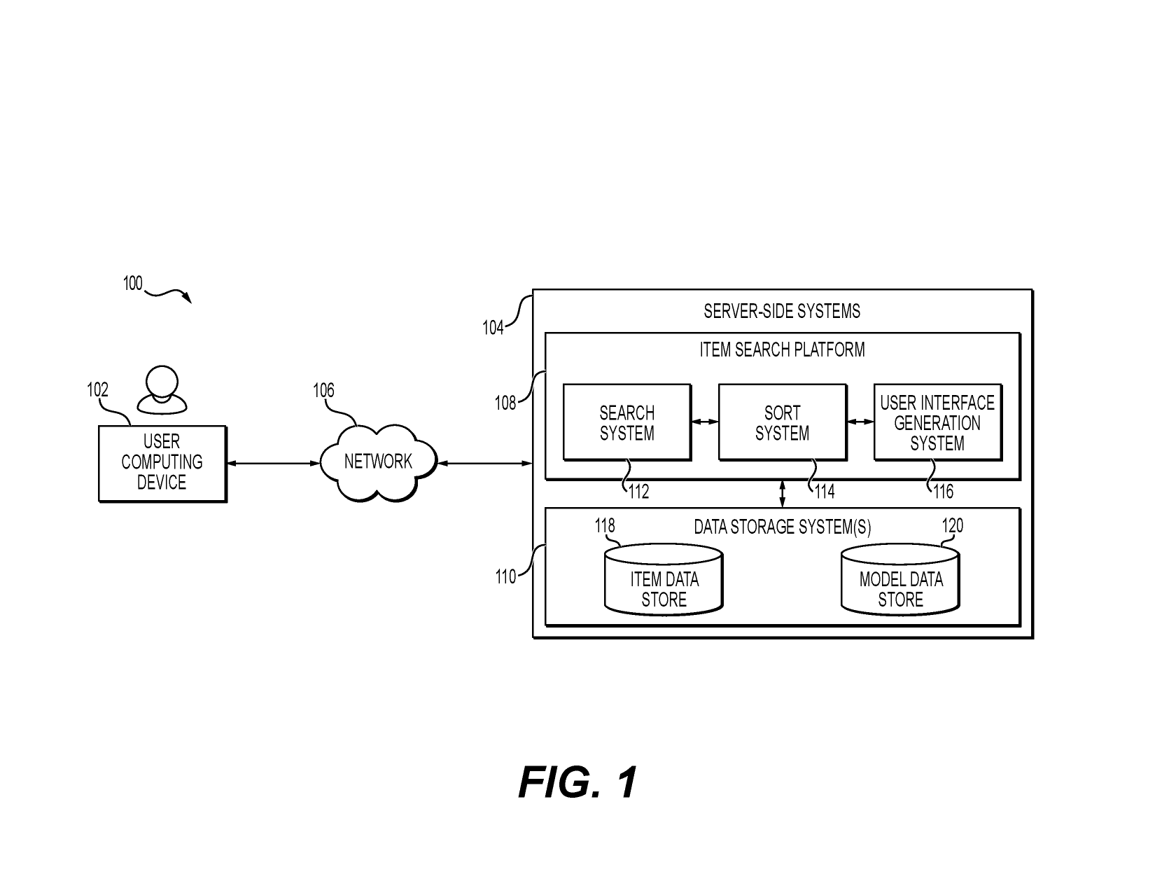

FIG. 1 is a diagram showing an example of a search environment 100, according to some embodiments of the disclosure. Search environment 100 may include a user computing device 102 communicating with one or more server-side systems 104 over a network 106. While one user computing device 102 is illustrated for brevity and clarity, the search environment 100 may support a plurality of user computing devices 102 communicating with the server-side systems 104 in parallel over the same network 106 or different networks.

The server-side systems 104 may include an item search platform 108 and one or more data storage system(s) 110, among other systems. In some examples, the item search platform 108 may be a sub-platform of a larger platform associated with a first entity. As one non-limiting example, the item search platform 108 may be a sub-platform of a content creation platform. The content creation platform may enable content creators to, among other things, search for items, via the item search platform 108, to include in monetized content generated and published via the content creation platform. In other examples, the item search platform 108 may be a standalone search platform or a sub-platform of any other type of e-commerce platform.

In some embodiments, item search platform 108 and the data storage system(s) 110 may be associated with a common entity (e.g., the first entity). In such embodiments, the item search platform 108 and the data storage system(s) 110 may be part of a cloud service computer system (e.g., in a data center). In other embodiments, the item search platform 108 and the data storage system(s) 110 may be associated with a different entity than one another. For example, the data storage system(s) 110 may be associated with a third party that provides data storage services to the first entity. The systems and devices of the search environment 100 may communicate in any arrangement. As will be discussed herein, systems or devices of the search environment 100 may communicate in order to facilitate item searches, among other activities.

The network 106 over which the one or more components of the search environment 100 communicate may include one or more wired or wireless networks, such as a wide area network (“WAN”), a local area network (“LAN”), personal area network (“PAN”), a cellular network (e.g., a 3G network, a 4G network, a 5G network, etc.) or the like. In some embodiments, the network 106 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” or “web page” or “page” generally encompasses a location, data store, or the like that is, for example, hosted or operated by a computer system so as to be accessible online, and that may include data configured to cause a program such as a web browser to perform operations such as send, receive, or process data, generate a visual display or an interactive interface, or the like. The user computing device 102 and one or more of the server-side systems 104 may be connected via the network 106, using one or more standard communication protocols. The user computing device 102 and one or more of the server-side systems 104 may transmit and receive communications from each other across the network 106, as discussed in more detail below.

The user computing device 102 may be configured to enable access to or interaction with other systems in the search environment 100 to transmit queries for item searches to, and receive search results responsive to the transmitted queries from, the item search platform 108. The user computing device 102 may be a computer system such as, for example, a desktop computer, a laptop computer, a tablet, a smart cellular phone (e.g., a mobile phone), a smart watch or other electronic wearable, etc.

In some embodiments, the user computing device 102 may include one or more electronic application(s), e.g., a program, plugin, browser extension, etc., installed on a memory of the respective devices. The electronic application(s) may include one or more of system control software, system monitoring software, software development tools, etc. In some embodiments, the electronic application(s) may be associated with one or more of the other components in the search environment 100. For example, one or more of the electronic application(s) may include client applications associated with one or more of the server-side systems 104 (e.g., a client application of the item search platform 108 and/or of a larger platform the item search platform 108 is a sub-platform thereof). In some examples, one or more of the client applications may include thick client applications that are locally installed on the user computing device 102 (e.g., desktop applications or mobile applications). In other examples, one or more of the client applications may include thin client applications (e.g., web applications) that are rendered via a web browser launched on the user computing device 102.

Additionally, the user computing device 102 may generate, or may cause to be generated, one or more graphic user interfaces (GUIs) based on instructions or information stored in the memory, instructions or information received from the other systems in the search environment 100, or the like and may cause the GUIs to be displayed via a display of the user computing device 102. The GUIs may be, e.g., mobile application interfaces or browser user interfaces and may include text, input text boxes, selection controls, or the like. The display may include a touch screen or a display with other input systems (e.g., a mouse, keyboard, etc.) for the users of the respective devices to control the functions thereof.

In some embodiments, the user computing device 102 may be associated with a content creator subscribed to the above-described content creation platform, of which the item search platform 108 is a sub-platform thereof. The content creator may interact with the content creation platform through a client application running on the user computing device 102 to generate content to recommend or otherwise promote an item of interest for which the content creator is seeking monetization for (e.g., seeking commissions based on purchases of the item resulting from interactions with the content). As part of the content generation process, the content creator may select an item search feature of the client application, and utilize this feature to initiate or generate a query to facilitate identification of the item of interest for inclusion in the content. Upon generation and submission of the query, the client application may transmit the query over the network 106 to the item search platform 108. In return, and as described in more detail below, the item search platform 108 may provide computer-executable instructions, via the client application over the network 106, to enable the user computing device 102 to construct and display an optimized user interface to present items determined to be responsive to the query. In other examples, one or more processing steps associated with the item search query or the determination of the optimized user interface may be performed by the user computing device 102 itself or in combination with the item search platform 108. In some embodiments, a user using the user computing device 102 to utilize an item search feature of the client application may be a consumer or follower of a content creator trying to locate one or more items of interest that may or may not be associated with the content creator.

The item search platform 108 may include one or more server devices (or other similar computing devices) for executing search services. Example search services may include, but are not limited to, tasks associated with: determining items responsive to queries and an associated relevance of the items to the queries, item clustering, relevance-based item ordering within the clusters, and enhanced item sorting to generate a display sequence to optimize a display of the results, and specifically to reduce item variant display redundancy. In some examples, and as illustrated in FIG. 1, the item search platform 108 may include a plurality of systems, such as a search system 112, a sort system 114, and a user interface generation system 116, each configured to perform a different subset of tasks to execute the search services, as described in detail below.

The data storage system(s) 110 may include a server system, computer-readable memory such as a hard drive, flash drive, disk, etc. In some embodiments, the data storage system(s) 110 include or interact with an application programming interface for exchanging data to other systems, e.g., one or more of the other components of the search environment 100, such as at least the item search platform 108. The data storage system(s) 110 may include a plurality of data stores, such as an item data store 118 and a model data store 120. The data stores may include or act as a repository or source for various types of data.

The item data store 118 may be configured to store a plurality of items queryable via the search system 112 of the item search platform 108. The items may include goods or merchandise, such as products available for purchase or sale by one or more retailers or merchants. The items may each have a plurality of attributes. Example item attributes may include a brand, a collection, a size, a color, and/or a retailer, among other similar attribute types, associated with a given item. The items stored in the item data store 118 may include items scraped from external resources (e.g., scraped from the Internet), items previously interacted with by users (e.g., in the content creation platform scenario, items previously included in generated content and/or saved, favorited, or otherwise interacted with by a content creator), or the like. The item data store 118 may be continuously updated to include new items as they are identified via scraping and/or via user interactions. In some embodiments, the item data store 118 may be a vector-based database configured to store the items as vector representations of the items (e.g., as item vector embeddings) in a vector embedding space. An item vector embedding for an item may be a mathematical representation generated based on the attributes comprising the item to capture a semantic meaning and/or relationship of the item attributes.

The items stored within the item data store 118 may include multi-variant items. A multi-variant item is an item having two or more item variants (e.g., item versions) that represent a same underlying item but have one or more differing attributes. Using a shoe as an example multi-variant item, two or more item variants for a shoe may include two or more shoes of a same brand and collection that are of differing sizes, colors, styles, and/or sold by different retailers. Thus, within the item data store 118, for a given multi-variant item, there may be two or more items that are item variants of the multi-variant item.

The model data store 120 may be configured to store any models, algorithms, and/or processes to be utilized by one or more components of the item search platform 108 to execute the search services.

Although depicted as separate components in FIG. 1, it should be understood that a component or portion of a component in the system of the search environment 100 may, in some embodiments, be integrated with or incorporated into one or more other components. For example, one or more of data storage system(s) 110 may be integrated with the item search platform 108 or the like. As another example, the search system 112, the sort system 114, and/or the user interface generation system 116 may comprise a single system of the item search platform 108. In some embodiments, operations or aspects of one or more of the components discussed above may be distributed amongst one or more other components. Any suitable arrangement or integration of the various systems and devices of the search environment 100 may be used.

In the following disclosure, various acts may be described as performed or executed by a component from FIG. 1, such as the user computing device 102 or one or more of the server-side systems 104, or components thereof. However, it should be understood that in various embodiments, various components of the search environment 100 discussed above may execute instructions or perform acts including the acts discussed below. An act performed by a device may be considered to be performed by a processor, actuator, or the like associated with that device. Further, it should be understood that in various embodiments, various steps may be added, omitted, or rearranged in any suitable manner.

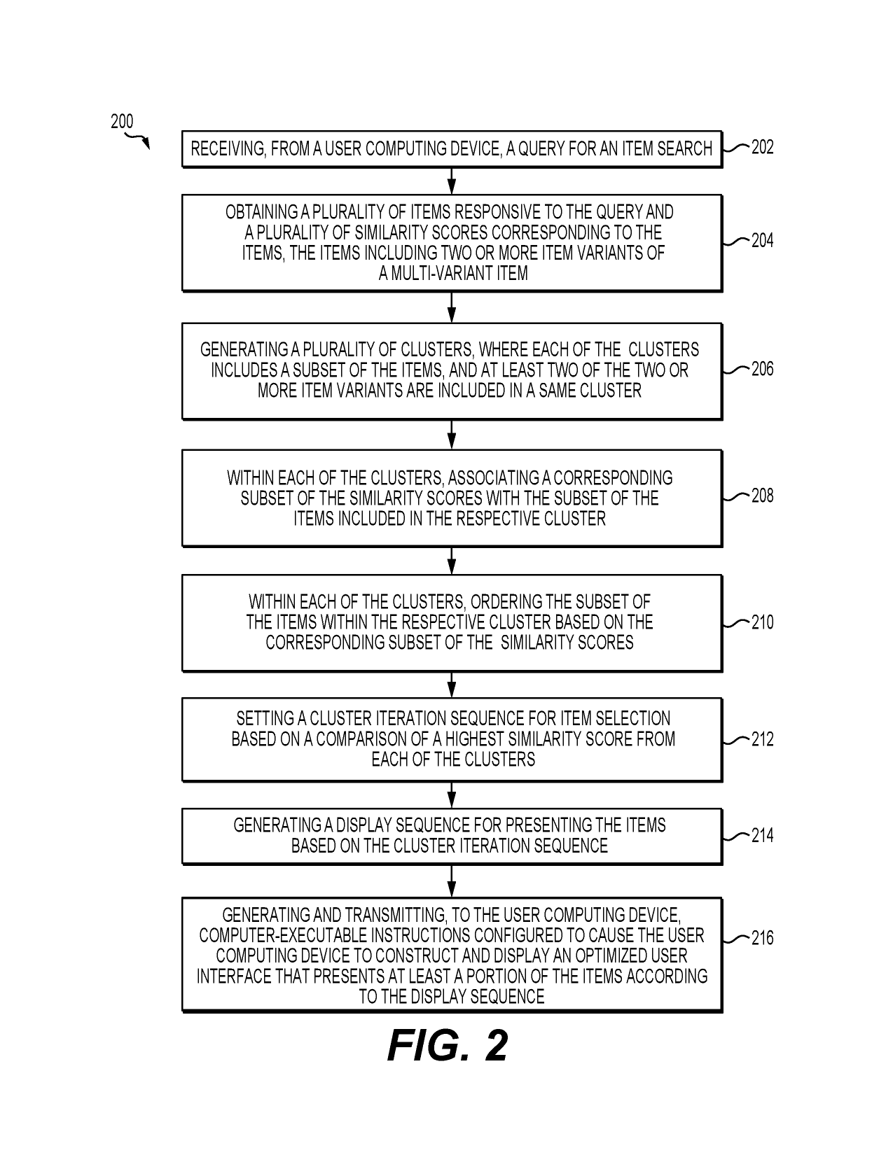

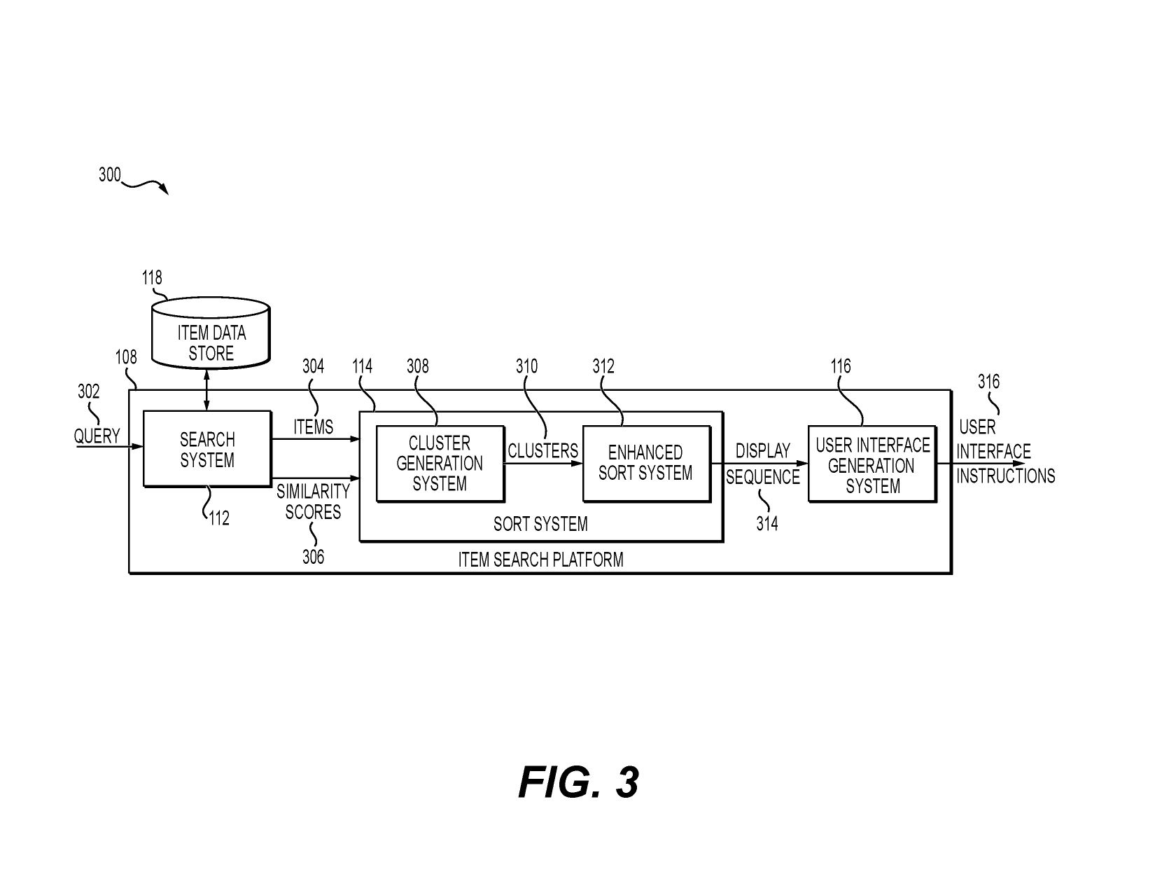

FIG. 2 is a flow chart showing an example process 200 for search result display optimization, according to some embodiments of the disclosure. FIG. 3 is a system flow diagram 300 conceptually showing the process 200 of FIG. 2, according to some embodiments of the disclosure. In some examples and as described with reference to FIGS. 2 and 3, the process 200 may be performed by one or more of the server-side systems 104, such as one or more components of the item search platform 108. However, in other examples, the process 200 may be performed by the user computing device 102 or by a combination of the item search platform 108 and the user computing device 102 (e.g., one or more steps of the process 200 may be performed by the item search platform 108 while one or more other steps of the process 200 may be performed by the user computing device 102).

Referring concurrently to FIGS. 2 and 3, at step 202, the process 200 may include receiving, from the user computing device 102, a query 302 for an item search. To provide an illustrative example, the client application associated with the content creation platform described above with reference to FIG. 1 may be running on the user computing device 102, and the content creator may select to navigate to an item search feature of the client application to initiate a generation of the query 302. In response to the selection, the client application may display a search user interface (e.g., an item search page) having one or more control elements, such as a search field and/or one or more search filter control elements, for entering a query 302. As one example, the content creator may intend to generate content that promotes or otherwise recommends (e.g., for monetization purposes) a new pair of running shoes. To help the content creator identify the new pair of running shoes for inclusion in the content to establish a monetization pathway, the content creator may enter “running shoes” as the query 302 via the search user interface. The user computing device 102, via the client application, may then transmit the query 302 over the network 106 to the item search platform 108.

At step 204, the process 200 may include determining a plurality of items 304 responsive to the query 302 and a plurality of similarity scores 306 corresponding to the items 304. The items 304 determined to be responsive to the query 302 may include two or more item variants of a multi-variant item.

To determine the items 304 responsive to the query 302, the search system 112 may query the item data store 118 to obtain the items 304. In examples where the item data store 118 is a vector-based database configured to store the items therein as item vector embeddings, as described above with reference to FIG. 1, the search system 112 may be configured to transform the query 302 to a query item vector embedding, and query the item data store 118 using the query item vector embedding. To transform the query 302, one or more natural language processing (NLP) techniques may be applied to the query 302 to extract item attributes from the query 302 for use in generating the query item vector embedding. Continuing to use “running shoes” as an example of the query 302, a type or category of item (e.g., “shoes”) and a sub-category thereof (e.g., “running”) may be extracted and used to generate a query item vector embedding that mathematically represents the item being queried for based on the extracted attributes and captures a semantic meaning and/or relationship between the extracted attributes.

A search of the vector embedding space (e.g., a multi-dimensional graph search) of the item data store 118 may be performed using the query item vector embedding to identify a plurality of item vector embeddings that are within a predefined distance of the query item vector embedding in the vector embedding space. The item vector embeddings being within the predefined distance of the query item vector embedding indicates a similarity in one or more attributes of items that the item vectors are representing with the attributes of the item being queried for, and thus a relevancy or responsiveness of those items to the query 302. Resultantly, the item vector embeddings identified may represent the items 304 determined to be responsive to the query 302.

Additionally, the similarity scores 306 for the items 304 may be determined using cosine similarity. For example, for each of the items 304, a cosine of an angle between the item vector embedding representing the respective item 304 and the query item vector embedding in the vector space is determined to yield a cosine similarity value for the respective item 304. A smaller cosine similarity value indicates increased similarity of the item vector embedding to the query item vector embedding, and thus a likely higher relevance or responsiveness of the respective item 304 to the query 302. The items 304 and corresponding similarity scores 306 may then be provided to the sort system 114 for use in clustering and enhanced sorting processes, as described in detail below.

At step 206, the process 200 may include generating a plurality of clusters 310. Each of the clusters 310 generated may include a subset of the items 304. Additionally, at least two of the two or more item variants of the multi-variant item may be included in a same cluster 310.

In some embodiments, the sort system 114 may include a plurality of sub-systems, including a cluster generation system 308 configured to generate the clusters 310 and an enhanced sort system 312 configured to perform an enhanced sorting process, described in more detail with reference to steps 212 and 214 below. In some examples, the cluster generation system 308 may obtain (e.g., from the model data store 120) and apply a hash-based clustering algorithm to generate the clusters 310. For example, using the algorithm, hashes may be generated for the items 304. An example hash for a respective item 304 can include a hash of a title associated with the item 304, a description association with the item 304, and/or other similar information associated with the item 304. The hashes for the items 304 are compared amongst one another to identify the subset of the items 304 to include in each cluster 310. For example, based on a predetermined threshold similarity between hashes of a first subset of the items 304, the first subset of the items 304 may be grouped together in a first cluster 310. Similarly, based on a predetermined threshold similarity between hashes of a second subset of the items 304, the second subset of the items 304 may be grouped together in a second cluster 310, and so on.

Because of the types of information used to generate the hashes for the items 304 (e.g., title, description, etc.), it may be common for item variants of a multi-variant item to be included in the same cluster 310. For example, the item variants may include a same or highly similar title (e.g., same brand name and style of shoe) and/or description (e.g., provided by a manufacturer of the shoe to all retailers). This causes the hashes generated for these item variants to fall within the predetermined threshold similarity, and result in the item variants being grouped together within a same cluster 310.

In other examples, in addition to the hash-based clustering described above, the cluster generation system 308 may further perform an embedding similarity search to refine the clusters (e.g., may apply embedding-based clustering). For example, for each item of the items 304 responsive to the query, the item vector embedding for the respective item may be compared against item vector embeddings of remaining items 304 to identify similar items based on the deeper context provided by the embeddings (e.g., based on the semantic meaning and/or relationship between item attributes captured by the embeddings). A similarity between the item vector embeddings may be determined using one or a combination of cosine similarity, dot product, or Euclidean distance. Based on the similarity between item vector embeddings exceeding a similarity threshold, the respective items represented by the item vector embeddings may be grouped together within a same cluster 310 (e.g., if they had not already been grouped into the same cluster 310 by the hash-based clustering). In other words, the clusters 310 may be updated or refined such that highly similar items are grouped within the same cluster.

To provide an illustrative example, the query 302 of “running shoes” provides limited context, and thus may result in a wide variety of the responsive items 304. However, each of the responsive items 304 may include a title and/or description that includes, for example, a shoe brand name, a shoe color, a shoe size, and/or a sport style, that is represented or captured by the item vector embedding for the respective item. Multi-variants of a same item will include highly similar titles and/or descriptions, and thus will include highly similar item vector embeddings. Continuing with the illustrative example, the title and/or description may be the same except for a different shoe color and/or a different shoe size. The highly similar item vector embeddings of multi-variant items may exceed the similarity threshold, and thus the application of the embedding-based clustering, may help to increase a likelihood (e.g., help to ensure) that multi-variant items are indeed grouped with one another in a same cluster 310.

In further examples, the embedding-based clustering may be performed separately from (e.g., as an alternative to) the hash-based clustering to generate the clusters 310.

At step 208, the process 200 may include, within each of the clusters 310, associating a corresponding subset of the similarity scores 306 with the subset of the items 304 included in the respective cluster 310. The items 304 within the clusters 310 may then be sorted, ranked, or otherwise ordered for display based, at least in part, on the similarity scores 306.

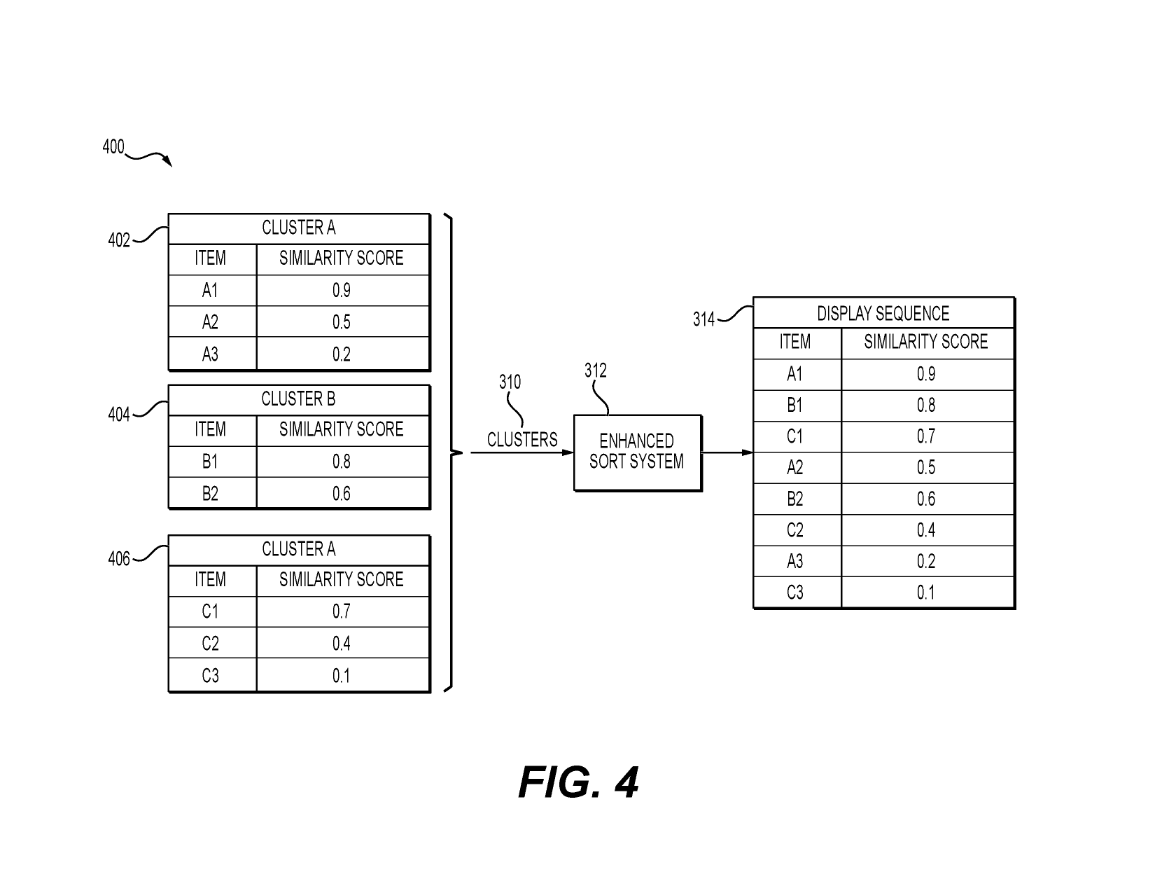

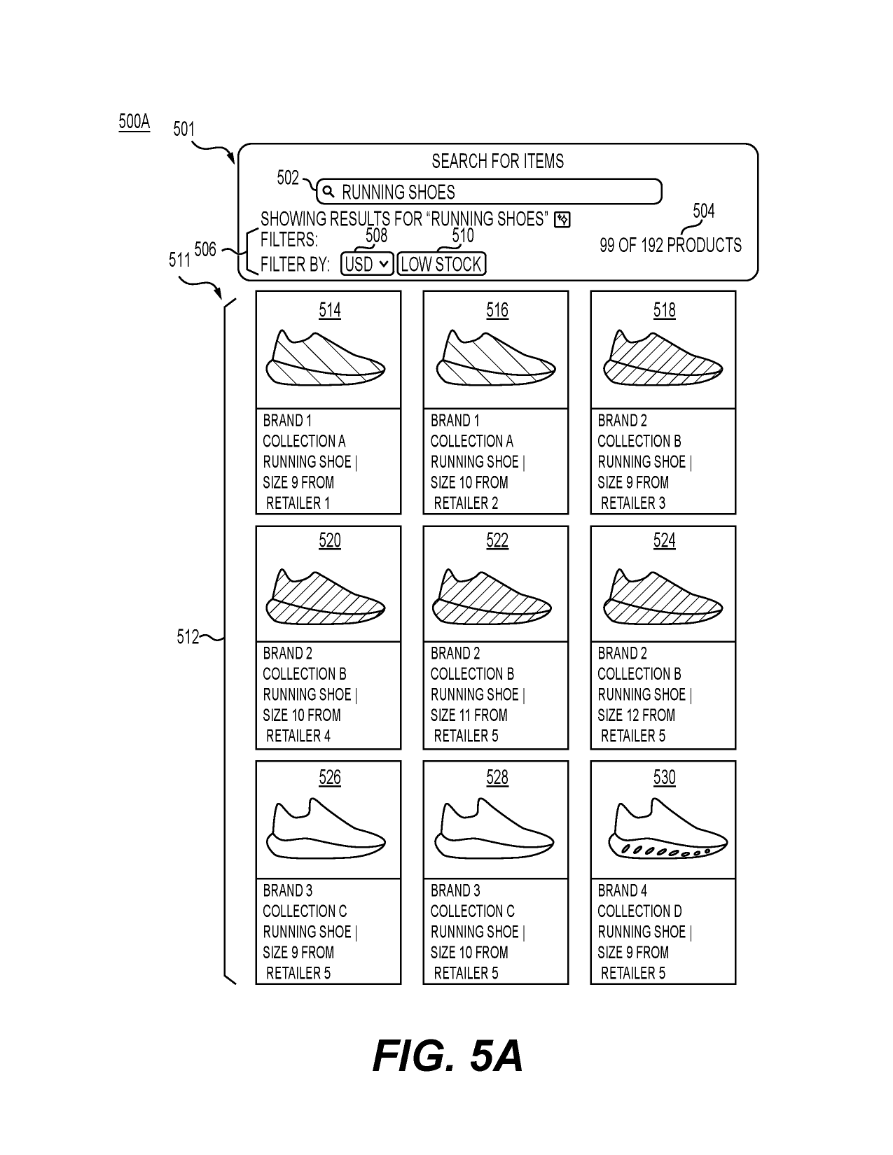

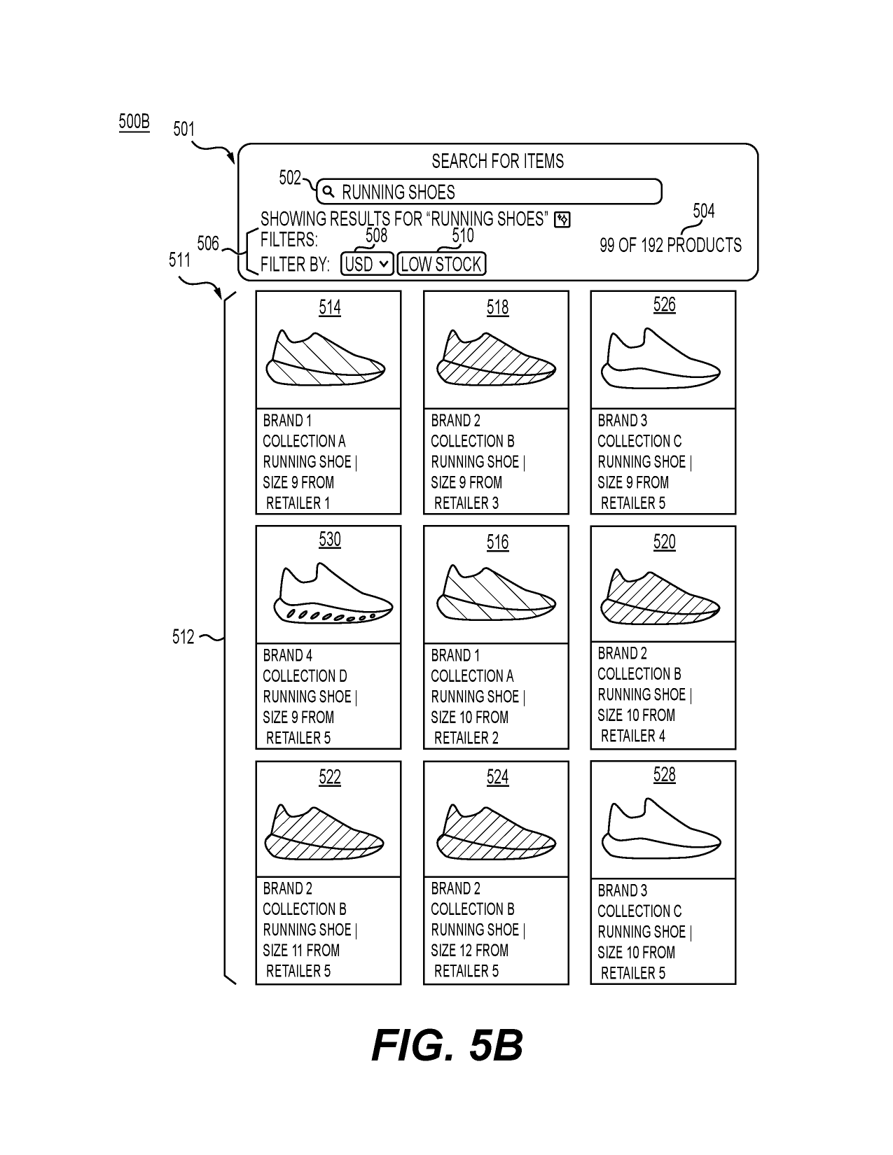

In some examples, the enhanced sort system 312 may be a sub-system of the sort system 114 that can be enabled and disabled. When enabled, the enhanced sort system 312 may be configured to receive the clusters 310, and perform an enhanced sorting process to reduce item variant display redundancy, as explained in further detail below. FIG. 4 is a conceptual diagram 400 illustrating an example of the enhanced sorting process performed as part of the process 200 of FIG. 2, according to some embodiments of the disclosure. FIGS. 5A and 5B provide clear depictions of the distinctions in the display of results when the enhanced sort system 312 is disabled (FIG. 5A) versus enabled (FIG. 5B).

Continuing with an example where the enhanced sort system 312 is enabled and the enhanced sorting process is performed, at step 210, the process 200 may include, within each of the clusters 310, ordering the subset of the items 304 within the respective cluster 310 based on the corresponding subset of the similarity scores 306. For example, within the clusters 310, the subset of the items 304 may be arranged as an ordered or ranked list. In some examples, the subset of the items 304 may be ordered from a highest similarity score to a lowest similarity score such that the items 304 from the subset that are likely to be more relevant to the query 302 are positioned higher in the ordered or ranked list. FIG. 4 provides an illustrative example. For example, as shown in FIG. 4, the clusters 310 may include a first cluster 402 (“Cluster A”), a second cluster 404 (“Cluster B”), and a third cluster 406 (“Cluster C”). Each of the first cluster 402, the second cluster 404, and the third cluster 406 include a list of the subset of the items 304 included in the respective cluster 402, 404, 406 and a corresponding subset of the similarity scores 306 for the items 304, where the items 304 are ordered or ranked within the list from highest to lowest similarity score (e.g., on a scale from 1 to 0). As previously mentioned, two or more of the items 304 within one or more of the clusters 310 may be item variants of a multi-variant item. For example, within the first cluster 402, item A1 and item A2 may be item variants.

Returning to process 200, at step 212, the process 200 may include setting a cluster iteration sequence for item selection based on a comparison of a highest similarity score 306 from each of the clusters 310. For example, to determine the cluster iteration sequence, a highest similarity score 306 for an item 304 included in each of the clusters 310 may be identified from the clusters’ lists and compared against one another. The clusters 310 may be ordered in a sequence starting with an initial cluster 310 having a highest of the highest similarity scores 306, followed by another cluster 310 having a next highest of the highest similarity scores 306, and so on until all the clusters 310 are included in the sequence.

Briefly returning to FIG. 4 to provide an illustrative example, highest similarity scores 306 for the first cluster 402, the second cluster 404, and the third cluster 406 are 0.9, 0.8, and 0.7, respectively. Therefore, the cluster iteration sequence set for the clusters 310 may start with the first cluster 402, follow with the second cluster 404, and end with the third cluster 406.

At step 214, the process 200 may include generating a display sequence 314 for presenting the items 304 based on the cluster iteration sequence set at step 212. The cluster iteration sequence defines an order by which an item 304 with a highest remaining similarity score 306 on the ordered or ranked list for a given cluster 310 will be selected from each of the clusters 310 in an iterative, round-by-round manner (e.g., the order of item selection). The display sequence 314 may include a listing of the items 304 in an order that the items 304 will be presented (e.g., defining a position or arrangement) within an optimized user interface. The order of the items 304 within the display sequence 314 may be generated based on (e.g., may correspond to) the order of item selection defined by the cluster iteration sequence.

Briefly returning to FIG. 4 to provide an illustrative example, based on the cluster iteration sequence set for the clusters 310 as described with reference to step 212, in a first round, an item 304 with a highest similarity score 306 may be selected starting from the first cluster (e.g., item A1), followed by the second cluster 404 (e.g., item B1), and completed with the third cluster 406 (e.g., item C1). The selected items 304 from the first round may be removed from the clusters 310. The cluster iteration sequence may be repeated in a second round, where an item 304 with a highest remaining similarity score 306 may be selected starting from the first cluster (e.g., item A2), followed by the second cluster 404 (e.g., item B2), and completed with the third cluster 406 (e.g., item C2). The selected items 304 from the second round may be removed from the clusters 310. The cluster iteration sequence may again be repeated in a third round, where an item 304 with a highest remaining similarity score 306 may be selected starting from the first cluster (e.g., item A3) and completed with the third cluster 406 (e.g., item C3). In the third round, the second cluster 404 is skipped or otherwise omitted from the cluster iteration sequence because no items 304 remain in the second cluster 404 to select from. The resulting display sequence 314 includes a listing of the items 304 corresponding to the order of item selection from each round (e.g., item A1, item B1, item C1, item A2¸ item B2, item C2, item A3, and item C3).

The cluster iteration sequence set at step 212 prevents two of the items 304 from being selected from a same cluster 310 sequentially, and thus two of the items 304 from a same cluster 310 being positioned immediately next to one another in the display sequence (at least initially until the items 304 available for selection have been depleted in all but one cluster 310). Therefore, given that item variants are often grouped within the same cluster 310, such as item A1 and item A2 within the first cluster 402, and the cluster iteration sequence at least initially prevents two of the items 304 from being selected from a same cluster 310 sequentially, the cluster iteration sequence prevents or at least reduces a likelihood of two or more item variants being sequentially selected and positioned immediately next to one another in the display sequence 314, and particularly within higher positions in the display sequence 314 and when embedding-based clustering is applied. For example, when the items 304 are presented according to the display sequence 314 within an optimized user interface as described in detail below, the item variants (e.g., item A1 and item A2) will not be displayed immediately next to one another. Rather, other unique items of relevance to the query 302 (e.g., item B1 and item C1) may be displayed more prominently along with only one of (and the most relevant of) the item variants (e.g., item A1).

In some examples, the items 304 determined to be responsive to the query 302 may include hundreds to thousands of items. Having to cluster and sort such a large number of items using the processes described above with reference to step 206 through step 214 may be computing resource intensive. Therefore, to help conserve computing resources, in some embodiments, the items 304 may be divided into a plurality of portions, and only one portion of the items 304 may be clustered and sorted, using the enhanced sorting process, for presentation via an optimized user interface at a time. For example, the portions of items 304 may correspond to a number of items that can be displayed on the user interface by the user computing device 102 at a given time (e.g., a number of items displayable per page of the user interface). Only portions of items 304 corresponding to pages to actually be displayed (e.g., in response to receiving an indication to display a next page) may be processed to further conserve resources.

In such embodiments, the portion of the items 304 for presentation within the optimized user interface may include a first portion of the items 304 corresponding to a first page, and only the first portion of the items 304 may be clustered and ordered to generate the display sequence 314 (e.g., a first display sequence for presenting the first portion of the items 304) based on the cluster iteration sequence. As the user interface is interacted with by a user to, for example, scroll beyond the first portion of the items 304 clustered and sorted for presentation within the first page of the user interface, an indication to display a second page may be received. In response to the indication, a second portion of the items 304 may be clustered and sorted based on the cluster iteration sequence to generate a second display sequence for presenting the second portion of the plurality of items within the second page of the user interface, and so on at run time.

Additionally, by portioning the items 304 for clustering, sorting, and presentation, a latency from a time the query 302 query is submitted to a time of result presentation via the optimized user interface may decrease.

At step 216, the process 200 may include generating and transmitting, to the user computing device 102, computer-executable instructions configured to cause the user computing device 102 to construct and display an optimized user interface that presents at least a portion of the items 304 according to the display sequence 314 (e.g., user interface instructions 316). For example, the user interface generation system 116 may receive the display sequence 314 from the sort system 114 for use in generating the user interface instructions 316. FIG. 5B provides an example of an optimized user interface constructed and displayed by the user computing device 102 using the user interface instructions 316.

The user interface instructions 316 may include information associated with how to visually display the items 304 within the optimized user interface. For example, the user interface instructions 316 may include a position or arrangement of the items 304 relative to one another within the optimized user interface based on the display sequence 314. To provide an illustrative example, the arrangement may indicate that the items 304 are to be displayed row by row, with N items per row listed in the order provided in the display sequence 314 from left to right. For example, referring to the example in FIG. 4, the user interface instructions 316 may indicate that items A1, B1, and C1 may be presented from left to right in a first row, items A2, B2, and C2 may be presented from left to right in a second row below the first row, and so on. Additionally, the user interface instructions 316 may include a style or format for presentation of the items 304, along with any images and/or text associated with the items 304 (e.g., obtained from the item data store 118) to display in accordance with the style or format.

As mentioned above, in some embodiments, to help conserve computing resources, only one portion of the items 304 may be clustered and sorted for presentation within the optimized user interface at a time (e.g., on a page-by-page basis). Therefore, a new set of user interface instructions 316, including information associated with how to visually display a next portion of the items 304 within the optimized user interface (e.g., the second portion of the items 304 based on the second display sequence), may be generated and transmitted to the user computing device 102 for use in constructing and displaying subsequent pages of the optimized user interface.

Accordingly, certain embodiments may be performed for search result display optimization to reduce item variant display redundancy. The process 200 described above is provided merely as an example, and may include additional, fewer, different, or differently arranged steps than depicted in FIGS. 2, 3, and/or 4 describing the process 200 and/or portions thereof.

FIG. 5A is an example user interface 500A displaying search results when the enhanced sorting process is disabled, according to some embodiments of the disclosure. The user interface 500A may be a search result user interface including a first portion 501 and a second portion 511. The first portion 501 includes a search field 502 via which the query 302 for the item search (e.g., “running shoes”) is indicated, along with a results indication 504 indicating a number of the items 304 determined responsive to the query 302, and one or more filter control elements 506 for adjusting or filtering the items 304 that are being presented within the second portion 511. As one example, the filter control elements 506 may include a price filter control element 508 via which a particular price range may be selected to cause only the items 304 falling within that particular price range (e.g., determined based on a price attribute for the items) to be presented within the second portion 511. As another example, the filter control elements 506 may include a low stock filter control element 510 that, when selected, causes only the items 304 that are currently in low stock at the associated retailer (e.g., determined based on a stock attribute for the items 304) to be presented within the second portion 511.

The second portion 511 may be dynamic, presenting only a portion of the items 304 at a time on a page-by-page basis. For example, within a first page shown in FIG. 5A, a first plurality of item tiles 512 corresponding to a first portion of the items 304 are presented in a first arrangement. The second portion 511 may then update to present a second plurality of item tiles corresponding to a second portion of the items 304 (not shown) as a user interacts with the user interface 500A to, for example, scroll past the item tiles 512 within the first page to view additional results.

The item tiles 512 may include a first item tile 514, a second item tile 516, a third item tile 518, a fourth item tile 520, a fifth item tile 522, a sixth item tile 524, a seventh item tile 526, an eighth item tile 528, and a ninth item tile 530. As illustrated, the item tiles 512 may each include an image and descriptive text associated with the corresponding item 304 from the first portion of the items. For example, the descriptive text may include various attributes of the corresponding item 304, such as a brand, a collection, a style, a size, and a retailer.

When the enhanced sorting process is disabled (e.g., the enhanced sort system 312 is not performing at least steps 212-214 of the process 200), a sequence of the first portion of the items 304 for display, and thus the first arrangement of the corresponding item tiles 512 shown in FIG. 5A results in item variants of multi-variant items being positioned immediately relative to (e.g., next to) one another. For example, the first item tile 514 and the second item tile 516 positioned immediately next to one another in the display correspond to item variants of a same first brand and collection of shoe (e.g., “Brand 1 Collection A”), but are of differing sizes and sold by different retailers. Similarly, the third item tile 518, the fourth item tile 520, the fifth item tile 522, and the sixth item tile 524 positioned immediately next to one another in the display correspond to item variants of a same second brand and collection of shoe (e.g., “Brand 2 Collection B”), but are of differing sizes and/or sold by different retailers. Further, the seventh item tile 526 and the eighth item tile 528 positioned immediately next to one another in the display correspond to item variants of a same third brand and collection of shoe (e.g., “Brand 3 Collection C”), but are of differing size.

This positioning of the item variants immediately next to one another detracts from other unique items of similar relevance that are positioned lower within the user interface 500A, such as the items 304 corresponding to the seventh item tile 526 and the ninth item tile 530. Resultantly, the user interface 500A provides a sub-optimal user experience due to the item variant display redundancy.

FIG. 5B is an example user interface 500B displaying search results when the enhanced sorting process is enabled, according to some embodiments of the disclosure. For example, the user interface 500B may be a search result user interface representing the optimized user interface constructed and generated based on the user interface instructions 316 transmitted from the item search platform 108 to the user computing device 102 at step 216 of the process 200. The user interface 500B includes the first portion 501 and the second portion 511, similar to the user interface 500A described with reference to FIG. 5A. However, within the second portion 511, the item tiles 512 are now presented in a second arrangement according to the display sequence 314 generated by the enhanced sort system 312.

Based on the display sequence 314, now at least an initial portion of the item tiles 512 presented in the user interface 500B (e.g., the first item tile 514, the third item tile 518, the seventh item tile 526, and the ninth item tile 530) represent all unique items 304 with no item variants positioned immediately next to one another. Thus, the user interface 500B reduces the item variant display redundancy present in the user interface 500A, while still enabling the item variants to be presented for viewing and/or selection at lower positions within the user interface 500B.

The user interfaces 500A and 500B described above are provided merely as an example, and may include additional, fewer, different, or differently arranged information and/or interactive control elements than depicted in FIGS. 5A and 5B.

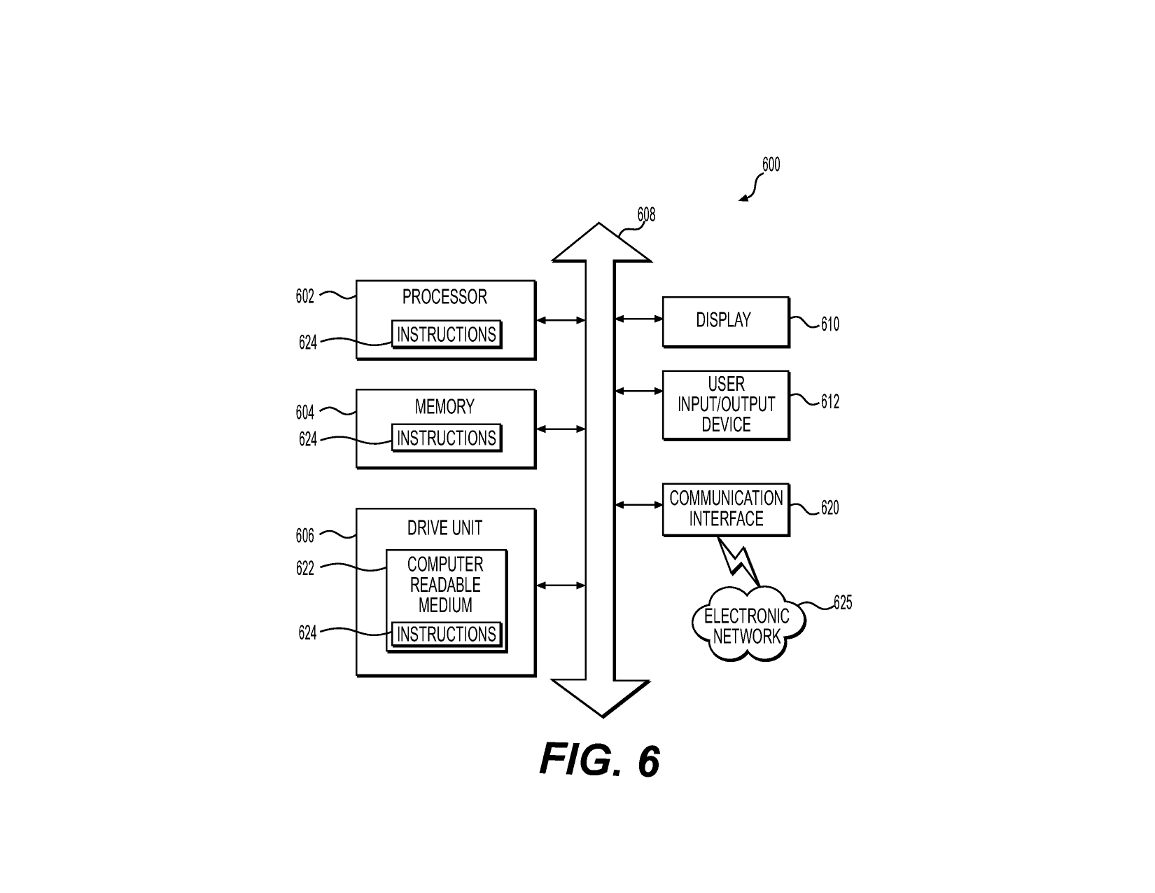

FIG. 6 shows an implementation of a computer system 600 that executes techniques presented herein, including processes or operations depicted in, or described with respect to, FIGS. 2-4, according to some embodiments of the disclosure. For example, the computer system 600 may be configured as one of the user computing device 102, one of the server-side systems 104, or another device according to exemplary embodiments of this disclosure. In various embodiments, any of the systems herein may be a computer system 600 including, e.g., a data communication interface 620 for packet data communication. The computer system 600 may communicate with one or more other computer systems 600 using the electronic network 625. The electronic network 625 may include a wired or wireless network similar to the network 106 depicted in FIG. 1.

The computer system 600 also may include a central processing unit (“CPU”), in the form of one or more processors 602, for executing program instructions 624. The program instructions 624 may include instructions for running one or more operations of the respective device or system. The computer system 600 may include an internal communication bus 608, and a drive unit 606 (such as read-only memory (ROM), hard disk drive (HDD), solid-state disk drive (SDD), etc.) that may store data on a computer readable medium 622, although the computer system 600 may receive programming and data via network communications. The computer system 600 may also have a memory 604 (such as random access memory (RAM)) storing instructions 624 for executing techniques presented herein, although the instructions 624 may be stored temporarily or permanently within other modules of computer system 600 (e.g., processor 602 or computer readable medium 622). The computer system 600 also may include user input and output ports 612 or a display 610 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, e.g., may enable loading of the software from one computer or processor into another. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be understood that embodiments in this disclosure are exemplary only, and that other embodiments may include various combinations of features from other embodiments, as well as additional or fewer features.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for search result display optimization, the method comprising:
receiving a query for an item search initiated via a user computing device;
determining a plurality of items responsive to the query and a plurality of similarity scores corresponding to the plurality of items, the plurality of items including two or more item variants of a multi-variant item;
generating a plurality of clusters, wherein each of the plurality of clusters includes a subset of the plurality of items, and at least two of the two or more item variants are included in a same cluster of the plurality of clusters;
within each of the plurality of clusters, associating a corresponding subset of the plurality of similarity scores with the subset of the plurality of items included in the respective cluster;
within each of the plurality of clusters, ordering the subset of the plurality of items within the respective cluster based on the corresponding subset of the plurality of similarity scores;
setting a cluster iteration sequence for item selection based on a comparison of a highest similarity score from each of the plurality of clusters;
generating a display sequence for presenting the plurality of items based on the cluster iteration sequence; and
causing the user computing device to construct and display an optimized user interface that presents at least a portion of the plurality of items according to the display sequence, the display sequence reducing a display redundancy of the at least two of the two or more item variants in the optimized user interface.

2. The computer-implemented method of claim 1, wherein generating the display sequence comprises:
iteratively selecting an item from the subset of the plurality of items having a highest remaining similarity score from each of the plurality of clusters according to an order of the plurality of clusters defined by the cluster iteration sequence.

3. The computer-implemented method of claim 2, wherein setting the cluster iteration sequence comprises:
defining the order of the plurality of clusters in the cluster iteration sequence from an initial cluster having a highest similarity score among the highest similarity score from each of the plurality of clusters to a final cluster having a lowest similarity score among the highest similarity score from each of the plurality of clusters.

4. The computer-implemented method of claim 1, wherein the cluster iteration sequence prevents the at least two of the two or more item variants included in the same cluster from being positioned immediately relative to another in the display sequence to reduce the display redundancy.

5. The computer-implemented method of claim 1, wherein:
the portion of the plurality of items presented are a first portion of the plurality of items corresponding to a first page, of a plurality of pages, of the plurality of items displayable on the optimized user interface at a given time, and
only the first portion of the plurality of items are clustered and ordered to generate the display sequence for presenting the first portion of the plurality of items based on the cluster iteration sequence.

6. The computer-implemented method of claim 5, wherein the display sequence is a first display sequence, and the method further comprising:
in response to receiving an indication to display a second page, of the plurality of pages, on the optimized user interface, clustering and ordering a second portion of the plurality of items corresponding to the second page to generate a second display sequence for presenting the second portion of the plurality of items based on the cluster iteration sequence.

7. The computer-implemented method of claim 1, wherein an item data store is a vector-based database configured to store item vector embeddings in a vector embedding space, and determining the plurality of items responsive to the query comprises:
transforming the query to a query item vector embedding; and
querying the item data store, using the query item vector embedding, to obtain the plurality of items, wherein the plurality of items determined to be responsive to the query correspond to a plurality of the item vector embeddings identified as being within a predefined distance of the query item vector embedding in the vector embedding space.

8. The computer-implemented method of claim 7, wherein determining the plurality of similarity scores corresponding to the plurality of items comprises:
determining a cosine similarity value between the query item vector embedding and each of the plurality of the item vector embeddings to yield a plurality of cosine similarity values for the plurality of items corresponding to the plurality of the item vector embeddings; and
determining the plurality of similarity scores for the plurality of items based on the plurality of cosine similarity values for the plurality of items.

9. The computer-implemented method of claim 1, wherein generating the plurality of clusters comprises:
generating a plurality of hashes for the plurality of items based on information associated with the plurality of items; and
comparing the plurality of hashes to identify the subset of the plurality of items included in each of the plurality of clusters based on a predetermined threshold similarity between a subset of the plurality of hashes corresponding to the subset of the plurality of items.

10. The computer-implemented method of claim 9, wherein the at least two of the two or more item variants are included in the same cluster of the plurality of clusters based on a similarity of information associated with the at least two of the two or more item variants.

11. The computer-implemented method of claim 1, wherein generating the plurality of clusters comprises:
for each item of the plurality of items, determining a similarity of an item vector embedding of the respective item to item vector embeddings of remaining items of the plurality of items in a vector embedding space; and
in response to determining a similarity above a threshold value between the item vector embedding of the respective item and at least one item vector embedding of at least one of the remaining items, including the respective item and the at least one of the remaining items in a same cluster, wherein the at least two of the two or more item variants are included in the same cluster of the plurality of clusters based on a similarity of item vector embeddings of the at least two of the two or more item variants exceeding the threshold value.

12. The computer-implemented method of claim 1, wherein the plurality of items each include a plurality of attributes, and the two or more item variants of the multi-variant item include two or more items, from the plurality of items, that represent a same item with one or more differing attributes of the plurality of attributes.

13. A system for search result display optimization, the system comprising:
one or more processors; and
at least one memory storing instructions that, when executed by the one or more processors, cause the one or more processors to perform operations including:
receiving a query for an item search initiated via a user computing device;
determining a plurality of items responsive to the query and a plurality of similarity scores corresponding to the plurality of items, the plurality of items including two or more item variants of a multi-variant item;
generating a plurality of clusters, wherein each of the plurality of clusters includes a subset of the plurality of items, and at least two of the two or more item variants are included in a same cluster of the plurality of clusters;
within each of the plurality of clusters, associating a corresponding subset of the plurality of similarity scores with the subset of the plurality of items included in the respective cluster;
within each of the plurality of clusters, ordering the subset of the plurality of items within the respective cluster based on the corresponding subset of the plurality of similarity scores;
setting a cluster iteration sequence for item selection based on a comparison of a highest similarity score from each of the plurality of clusters;
generating a display sequence for presenting the plurality of items based on the cluster iteration sequence; and
causing the user computing device to construct and display an optimized user interface that presents at least a portion of the plurality of items according to the display sequence, the display sequence reducing a display redundancy of the at least two of the two or more item variants in the optimized user interface.

14. The system of claim 13, wherein generating the display sequence comprises:
iteratively selecting an item from the subset of the plurality of items having a highest remaining similarity score from each of the plurality of clusters according to an order of the plurality of clusters defined by the cluster iteration sequence.

15. The system of claim 14, wherein setting the cluster iteration sequence comprises:
defining the order of the plurality of clusters in the cluster iteration sequence from an initial cluster having a highest similarity score among the highest similarity score from each of the plurality of clusters to a final cluster having a lowest similarity score among the highest similarity score from each of the plurality of clusters.

16. The system of claim 13, wherein the cluster iteration sequence prevents the at least two of the two or more item variants included in the same cluster from being positioned immediately relative to another in the display sequence to reduce the display redundancy.

17. The system of claim 13, wherein:
the portion of the plurality of items presented are a first portion of the plurality of items corresponding to a first page, of a plurality of pages, of the plurality of items displayable on the optimized user interface at a given time, and
only the first portion of the plurality of items are clustered and ordered to generate the display sequence for presenting the first portion of the plurality of items based on the cluster iteration sequence.

18. The system of claim 17, wherein the display sequence is a first display sequence, and the operations further include:
in response to receiving an indication to display a second page, of the plurality of pages, on the optimized user interface, clustering and ordering a second portion of the plurality of items corresponding to the second page to generate a second display sequence for presenting the second portion of the plurality of items based on the cluster iteration sequence.

19. The system of claim 13, wherein the plurality of items each include a plurality of attributes, and the two or more item variants of the multi-variant item include two or more items, from the plurality of items, that represent a same item with one or more differing attributes of the plurality of attributes.

20. A non-transitory computer readable medium for search result display optimization, the non-transitory computer readable medium storing instructions which, when executed by one or more processors, cause the one or more processors to perform operations comprising:
receiving a query for an item search initiated via a user computing device;
determining a plurality of items responsive to the query and a plurality of similarity scores corresponding to the plurality of items, the plurality of items including two or more item variants of a multi-variant item;
generating a plurality of clusters, wherein each of the plurality of clusters includes a subset of the plurality of items, and at least two of the two or more item variants are included in a same cluster of the plurality of clusters;
within each of the plurality of clusters, associating a corresponding subset of the plurality of similarity scores with the subset of the plurality of items included in the respective cluster;
within each of the plurality of clusters, ordering the subset of the plurality of items within the respective cluster based on the corresponding subset of the plurality of similarity scores;
setting a cluster iteration sequence for item selection based on a comparison of a highest similarity score from each of the plurality of clusters;
generating a display sequence for presenting the plurality of items based on the cluster iteration sequence; and
causing the user computing device to construct and display an optimized user interface that presents at least a portion of the plurality of items according to the display sequence, the display sequence reducing a display redundancy of the at least two of the two or more item variants in the optimized user interface.
